(19) United States
(12) Patent Application Publication
(10) Pub. No.: US 2001/0023507 A1
(43) Pub. Date: Sep. 27, 2001

(54) Patient carrying platforms

(76) Inventor: Gavin Hugh James, Hereford (GB)

Correspondence Address: YOUNG & THOMPSON, 745 SOUTH 23RD STREET 2ND FLOOR, ARLINGTON, VA, 22202

(21) Appl. No.: 09/795,323

(22) Filed: Mar. 1, 2001

(30) Foreign Application Priority Data
Mar. 1, 2000 (GB) 0004795.1

(51) Int. Cl. A61G 7/10

(52) U.S. Cl. 5/86.1

(57) ABSTRACT

A moveable support platform incorporates a base plate 1 mounted on front castor wheels 2 and rear castor wheels 3. Side struts 7 extend up from the base plate 1 and between these is mounted a gripping and pushing bar 8. At a central location of the base plate 1 a guide cover 11 supports the spindle of a larger wheel 12. A patient standing on the base plate 1 can support himself by gripping the bar 10 and can be moved around on the base plate 1 by a helper. When it is necessary to move the construction around a corner or to rotate into the reverse direction, pushing or pulling on the bar 8 will tend to rotate the whole support platform construction generally about the central wheel 12, with the various pulley wheels rotating around the axis of the wheel 12.

Platforms for standing or seated patients are provided on a wheeled base so that the patient can be moved from one point to another. However, they are often difficult to manoeuvre around corners or to rotate so as to return in a reverse direction.

According to the present invention, there is provided a support platform for carrying a patient or other load and comprising a base plate mounted on wheels positioned at four corner positions of the platform, the platform also having a larger wheel or ball bearing located at a central position of the base plate.

The provision of the central wheel or ball bearing enables the support platform to be swivelled easily when it is necessary to change direction, as the rotation takes place about the central position where the wheel or ball bearing is located, whilst the corner wheels spin round into a new direction.

Preferably the wheels at the corners will be castor-type wheels.

The central larger wheel could be mounted about a spindle located in a support structure projecting above the base plate. In any event, it is preferred that the central wheel or ball bearing should be located closer to the forward pair of wheels that to the rearward pair of wheels.

The support platform can include a raised gripping bar and/or a seat for a patient.

The invention may be performed in various ways and a preferred embodiment thereof will now be described with reference to the accompanying drawings, in which:

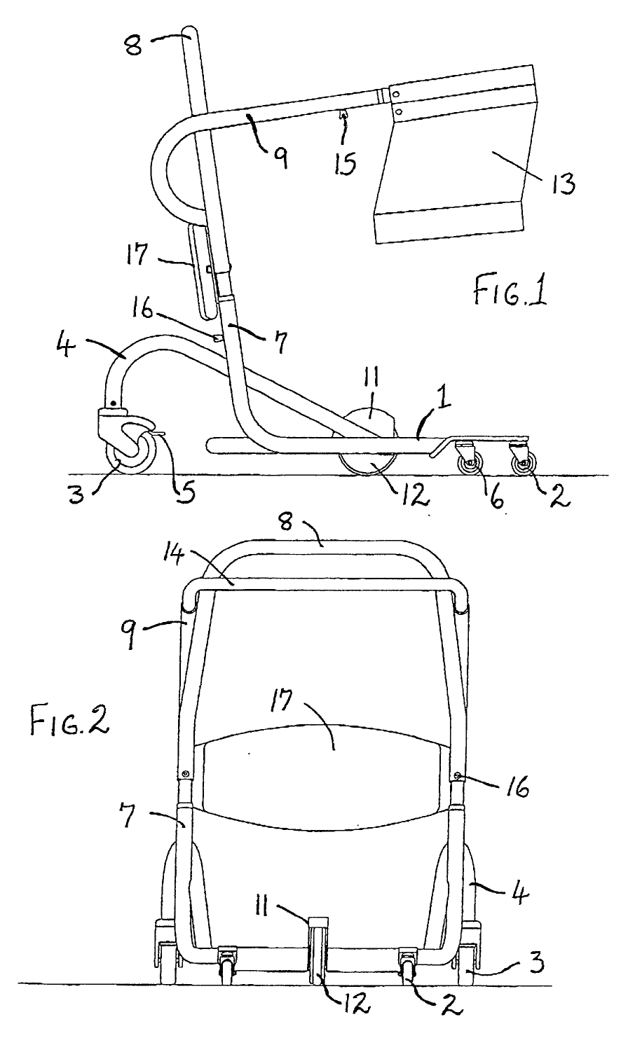

FIG. 1 is a side view of a patient support platform of this invention;

FIG. 2 is a rear view of the platform of FIG. 1;

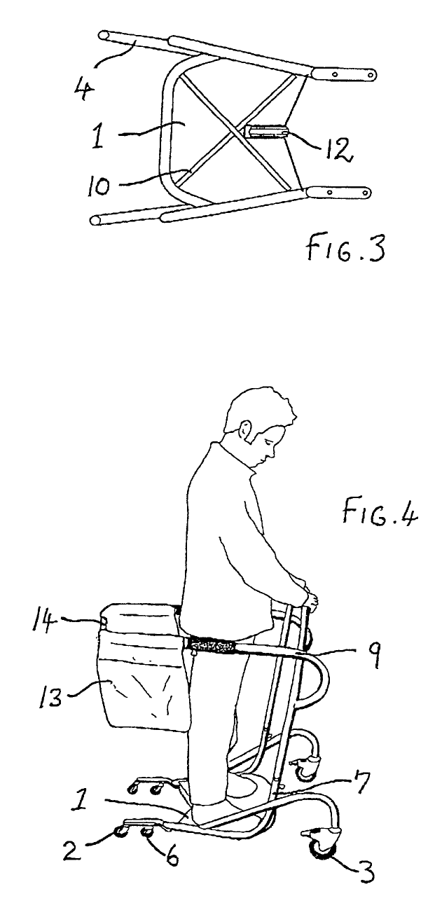

FIG. 3 is an underneath plan view of part of the support platform shown in FIGS. 1 and 2; and

FIG. 4 shows the support platform of FIGS. 1 to 3 in use.

The construction illustrated in the drawings incorporates a base plate 1 mounted on front castor wheels 2 and rear castor wheels 3. The rear wheels 3 are located at the ends of extended support legs 4 and incorporate wheel locking mechanisms 5. An auxiliary pair of wheels 6 can be provided towards the front of the base plate 1 if desired. Side struts 7 extend up from the base plate 1 and between these is mounted a gripping and pushing bar 8. Side arms 9 project from the struts 7. Strengthening struts 10 are provided below the base plate 1. At a central location of the base plate 1 a guide cover 11 supports the spindle of a larger wheel 12.

The base plate 1 provides a standing area in which a patient can stand with feet either side of the central wheel 12. The patient can support himself by gripping the bar 10 The patient can then be moved around on the base plate 1 by a helper who will push the construction around by means of the push bar 8. When it is necessary to move the construction 1 around a corner or to rotate into the reverse direction, pushing or pulling on the bar 8 will tend to rotate the whole support platform construction generally about the central wheel 12, with the various pulley wheels rotating around the axis of the wheel 12. It will be appreciated that the wheel 12 could be replaced by a large ball bearing, about which the structure can be rotated.

If desired, a seat could be provided on a rearward extension of the structure for a seated patient. This seat could be in the form of a canvas bucket seat 13 (FIGS. 1 and 4) fitted over a support bar 14 fitted into the side arms 9. The bar 14 could also be used as an alternative push bar to enable the platform to be pushed from the other end. Releasable locking members 15 can allow the bar 14 to be attached or removed as desired. Also the bar 8 can be removed or attached by locating into the side struts 7 for which releasable locking members 16 are provided. The bar 8 additionally carries a protective plate 17.

1. A support platform for carrying a patient or other load and comprising a base plate mounted on wheels positioned at four corner positions of the platform, the platform also having a larger wheel or ball bearing located at a central position of the base plate.

2. A support platform according to claim 1, wherein the wheels at the corners are castor-type wheels.

3. A support platform according to claim 1, wherein said larger wheel is mounted about a spindle located in a support structure projecting above the base plate.

4. A support platform according to claim 1, wherein said larger wheel or ball bearing is located closer to the forward pair of wheels than to the rearward pair of wheels.

5. A support platform according to claim 1, and incorporating a raised gripping bar.

6. A support platform according to claim 1, wherein a seat is provided on the platform for a patient.

7. A support platform according to claim 6, wherein the seat is carried by a pair of raised arms projecting over the base plate towards the forward pair of wheels.
